(19) United States
(12) Patent Application Publication
(10) Pub. No.: US 2008/0032023 A1
(43) Pub. Date: Feb. 7, 2008

(54) STABLE TABLETOP GRANULATED LOW CALORIE SUGAR SUBSTITUTES

(76) Inventor: Fidele Fonkeu, Easton, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/464,630

(22) Filed: Aug. 15, 2006

(51) Int. Cl. A23L 1/236

(52) U.S. Cl. 426/548

(57) ABSTRACT

The present invention is directed to a bulked sweetener composition comprising an intimate mixture of maltodextrin and a high intensity sweetener. The inventive composition is preferably produced by spray drying in which carbon dioxide is introduced into the feed stream to the spray dryer at a selected point.

The present invention is directed to a new spray-drying process for producing an enhanced granulated sugar substitute that are rigid particles, which can withstand breakage during transportation and better preserve the shipping volume; that have uniform particle sizes, which can help deliver accurate sweetness level when measured cup per cup; and less-to-no dusty effect.

### BACKGROUND OF THE INVENTION

Low calorie granulated sugar substitutes are popular with consumers and can be provided in many convenient forms. However, granulated sugar substitutes can exhibit specific physical characteristics that are not desirable. For example, the particles tend to be fragile, which can cause the density of the product to change and the sweetness level to be inaccurate when measured cup per cup over time. Granulated products can also exhibit high concentration of fines that affect the sweetness level of the product and may create dust during use. Many granulated product also can have poor dissolution rate in beverage solutions that negatively impact the expected sweetness level. Some products exhibit poor stability during transportation that can impact the original shipping volume. Finally, some granulated products have poor particle uniformity that can cause variations in sweetness level.

High intensity sweeteners can provide the sweetness of sugar (although often with a slightly different taste), but because they are many times sweeter than sugar, only a small amount is needed to replace the sugar. Therefore, in solid and semi-solid food applications (e.g., table sugar substitutes, baked goods, fruit pie fillings, cereal bars, semi-solid comestibles such as ice cream, soft candies, gelatins, custards, puddings, sweet sauces, and the like), high intensity sweeteners are usually mixed with a bulking agent. The intent is for the bulking agent to fulfill as many of sugar's roles as possible.

It is known to produce high intensity sweeteners, particularly sucralose by spray drying solutions of maltodextrin and sucralose or related compounds. Example 6 in U.S. Pat. No. 4,435,440 shows the preparation of a bulked sweetener by mixing maltodextrin and 4,1′-dichloro-4,1′-dideoxygalactosucrose or 4,1′,6′-trichloro-4,1′,6′-trideoxygalactosucrose and spray drying the solution. There are no process particulars disclosed in the examples or otherwise in the specification. The resulting bulked sweetener is indicated as having a bulk density of 0.2 g/cm³.

It is known that carbon dioxide can be used and injected into spray drying systems as a drying agent, such as shown in U.S. Pat. No. 7,008,644, though it has not been taught to introduce carbon dioxide in the feed line to the spray drier for the manufacture of bulked sweetener compositions as described herein.

### SUMMARY OF THE INVENTION

The present invention relates to bulked, granulated sweetener compositions comprising intimate mixtures of maltodextrin and a high intensity sweetener such that the bulked, granulated sweetener has a loose bulk density of not greater than about 0.15 g/cm³. The inventive compositions are advantageously produced by spray drying a solution of maltodextrin and a high intensity sweetener, such as sucralose, wherein carbon dioxide is injected into the spray dryer feed line after a high-pressure pump and prior to atomization within a spray dry chamber.

### BRIEF DESCRIPTION OF THE FIGURE

FIG. 1 is a schematic diagram of the process unit for making bulked sweetener compositions.

### DETAILED DESCRIPTION OF THE INVENTION

This invention relates to sweetener composition comprising a dextrin and a high intensity sweetener, such as the sweeteners exemplified by the group of sucralose, aspartame, saccharin, cyclamate, neotame, alitame, acesulfame potassium; brazien; stevia extract; and their salts and derivatives thereof; and mixtures thereof. The high intensity sweetener can be sucralose or a blend of sucralose with another high intensity sweetener. Alternatively, the high intensity sweetener is sucralose (4,1′,6′-trichloro-4,1′,6′-trideoxygalactosucrose), which is combined with maltodextrin. The sweetener composition is preferably in the form of a granulate resulting from a spray dried solution of sucralose and maltodextrin.

The preferred high intensity sweetener that is employed in the invention is sucralose, which is the compound 4,1′,6′-trichloro-4,1′,6′-trideoxygalactosucrose. Sucralose is especially preferred in recipes that require thermal processing (baking, retorting, extrusion, etc.), because of its heat stability and high quality sensory attributes. In the preparation of prepared foods (baked goods, comestibles, etc.), sucralose (or other high intensity sweetener) is used in the recipe in the amount to provide the equivalent amount of sweetness of the sugar it replaces. Sucralose is about 600 times as sweet as sugar. In preparing table sugar substitute (to be used in home baked goods, in hot or iced coffee and tea, on cereals and fruits, and in other foods to replace sugar), the sucralose/maltodextrin composition can advantageously be produced by co-spray drying.

Maltodextrins are produced from the hydrolysis of starch. They have the same general formula as carbohydrates but are of shorter chain length. Maltodextrin is a moderately sweet polysaccharide used as a food additive that is produced from corn starch and is usually found as a creamy white hygroscopic powder.

Maltodextrin is easily digestible, being absorbed as rapidly as glucose. The CAS number of maltodextrin is 9050-36-6.

In a preferred embodiment of the present invention, the maltodextrin prior to hydrogenation has the following general structure

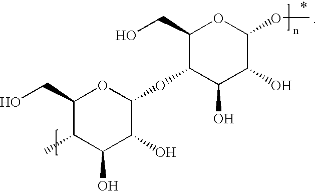

Under FDA guidelines, maltodextrin consists of non-sweet, nutritive saccharide polymers having a D.E. of less than 20, where D.E. refers to digestible energy. In another preferred embodiment, the maltodextrin prior to hydrogenation has a DE from about 5 to about 18. In a highly preferred embodiment, the maltodextrin prior to hydrogenation has a DE from about 8 to about 18. In the most-preferred embodiment, the maltodextrin prior to hydrogenation has a DE from about 9 to 11.

The maltodextrin/high intensity sweetener mixture is used in the preparation of baked goods and other solid or semi-solid comestibles in an amount such that the caloric content of the comestible is significantly less than the corresponding comestible made with sugar (e.g., from about 5% fewer calories up to a one-third or more reduction in calories).

The maltodextrin/sucralose tabletop composition can be a cup-for-cup replacement of sugar in home recipes. Maltodextrin and sucralose or other high intensity sweetener(s) can be prepared according to the aforementioned levels.

Applicants obtained particularly satisfactory results by using spray-drying as the means for preparing the inventive sweetener compositions. Aqueous co-solutions of sucralose and maltodextrin are spray-dried to produce the granulated sugar substitute. Thus, according to the present invention there is provided a sweetener composition comprising particles of sucralose adhering to maltodextrin in an intimate mixture, the bulked sweetener composition containing between about 1.1% to about 5% sucralose and between about 95% and 99.9% maltodextrin, on a dry weight basis.

An essential part of the present invention is that the resulting bulked sweetener composition have a loose bulk density of not greater than about 0.15 g/cm³, alternatively, not more than about 0.12 g/cm³, more preferably about 0.11 g/cm³. It is surprising that a granulated sweetener composition can be achieved having the desired loose bulk density using a spray drying system to produce the granulated product.

The sweetener compositions of the present invention may optionally contain other water-dispersible ingredients such as other high intensity sweeteners and flavorings. In particular, sweetener concentrates comprising synergistic combinations of sucralose with other high intensity sweeteners such as saccharin, acesulfame-K and stevioside and cyclamate are of interest. Other useful sweetener concentrates include those containing sucralose and dipeptide sweeteners.

The spray-drying apparatus used in the process of the invention can be any of the various commercially available apparatus. An example of a suitable spray-drying apparatuses is the Niro Dryer (manufactured by Niro Atomizer Ltd., Copenhagen, Denmark). A system having a spray dryer and a high pressure pump and an injection feed for an air stream containing primarily carbon dioxide gas between the high pressure pump and injector nozzles is particularly preferred. Other known atomizing agents, such as air, do not achieve desired results of loose bulk density and the agglomeration is unsatisfactory. Other gases are generally not suitable. Nitrogen, for example, would freeze the feed material and cause extensive damage to operation units, while argon and helium would not dissolve in the feed material. Notwithstanding the foregoing, insubstantial amounts of these gases or mixtures of such gases could be combined with the carbon dioxide feed provided the desired bulk density is achieved.

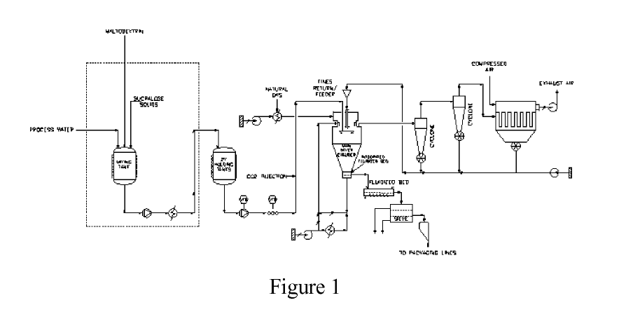

The preferred process for manufacturing the inventive sweetener composition will be described by reference to the attached FIG. 1. Maltodextrin, a high intensity sweetener, such as sucralose, and water are introduced via lines 11, 12, and 13 and mixed at a selected ratio into a jacketed mix tank 10. The sucralose is preferably introduced into mix tank 10 as a solid particle, though other forms, such as liquid solutions or suspensions could be utilized. As described above, maltodextrin is also typically added as a solid particle, though maltodextrin also could be introduced into mix tank 10 as a liquid solution or suspension. These ingredients are mixed at an elevated temperature in a static mix tank 10 in known fashion to produce a spray solution.

The resulting spray solution has a solids content of between about 55% to about 60% by weight, preferably about 58%. The viscosity of the spray solution is about 190 centipoise (cps) to about 300 cps at the selected operating temperatures, preferably about 250 cps. Two factors affect the viscosity: 1) temperature; and 2) the solids content of the solution. In order to maintain the spray solution within desired viscosity ranges for atomization, an in-line heat exchanger is installed and operated to compensate for the increase of viscosity resulting from the addition of liquid carbon dioxide and consequent change in solution temperature. The heat exchanger could be any type but preferably is an electrical thermo plate.

The expected operating temperature range for static mix tank 10 is about 125 F to about 145 F and the solids content is about 55% to about 60%. A Brookfield Viscometer can be used to measure the viscosity of the spray solution. A Brookfield Viscometer measures the viscosity of a spray solution by measuring the shear force or friction in layers of the solution. The higher the shear force in those layers, the higher the viscosity, and vice versa. Since temperature has a significant effect on the viscosity, the solution to be tested must be handled in the same manner and measured under the same operating conditions such as: temperature, spindle number of the viscometer and duration of the measurement. Brookfield Laboratory Viscometers are accurate within +/−1.0% of the range in use and are reproducible within +/−0.2%.

The spray solution from mix tank 10 is pumped into a jacketed holding tank 14 and maintained at a temperature of about 125 F to about 145 F, preferably about 140 F, with a conventional heating source (not shown). The spray solution is then fed via feed line 15 using a high-pressure pump (HPP) 16 into a spray dryer chamber 18 through nozzles 20 in the vicinity of a chamber inlet 21 to atomize the spray solution in known fashion. Nozzles 20 atomize the spray solution flowing out of holding tank 14 into droplets. Nozzles or atomizers suitable for use with the present invention include, but are not limited to, rotary atomizers, pressure, ultrasonic, vibrating plate, and electrostatic nozzles, and combinations of the foregoing.

The temperature at chamber inlet 21 is about 330 F to about 370 F, more preferably about 338 F. Liquid carbon dioxide (CO₂) is injected into feed line 15 at a point located between HPP 16 and nozzles 20. The location of the feed point is essential for achieving the desired low loose bulk density during spray drying. The liquid CO₂ is introduced at a rate of about 0.010-0.018 kg CO₂/kg feed preferably about 0.014 kg CO₂/kg feed.

Spray-dryer chamber 18 consists of two connected zones: The main chamber zone 22 and an integrated fluidized bed zone 24 both of which evaporate and agglomerate the particles to achieve the uniformity of the particles. The temperature at the inlet to the integrated fluidized bed zone 24 is about 185 F to about 200 F, more preferably about 195 F.

The droplets formed by nozzles 20 are dried in spray dryer chamber 22 to form dry particles. A drying gas is used in spray dryer 18 to dry the droplets to form dried particles. Examples of gases suitable for use with the present invention include, but are not limited to, air, nitrogen, argon, carbon dioxide, helium, and combinations or mixtures thereof. In a preferred embodiment, air is used. Air supply 26 is coupled to spray dryer 18, through suitable valves and regulators as would be apparent to one skilled in the art.

Fluidized bed zone 24 incorporates a multi-zone vibratory fluidized bed directly onto the spray dry chamber 18. The temperature at the inlet for Zone 1 for the vibratory fluidized bed 24 is about 170 F to about 180 F, more preferably about 176 F. The temperature at the inlet for Zone 2 for the vibratory fluidized bed 24 is about 65 F to about 80 F, more preferably about 68 F.

The temperature at the outlet for the spray dry chamber 18 is about 190 F to about 220 F, more preferably about 210 F. The dried particles exiting the spray dry chamber 18 having a moisture content of about 3 to 5%.

The resulting particles can then be screened, for example, using size screening methods known to one skilled in the art. In one embodiment, the dried particles exiting from integrated fluidized bed 24 are discharged into an external fluidized bed 26, which removes fines and further agglomerates the particles and adjusts the moisture content of the granulated product. External fluidized bed 26 removes small fines from the granulated product composition and ultimately returns the small fines to spray drying chamber 18 after being separated in cyclones 30 and/or 32.

From the external fluidized bed 26, the granulated product passes through a multi-layered sifter 34, which removes over-sized particles from the top row and fines from below to produce a uniform bulked granulated sweetener product.

Exhaust air from spray dryer chamber 18 and cyclones 30 and 32 are filtered through a food grade bag house in known fashion. The inventive sweetener compositions desirably have a high percentage of particles that are generally globular and are retained on a 20 mesh screen, such as at least about 18% but not more than about 24%. Preferably, the inventive sweetener composition contains a percentage of particles that are retained on a 60 mesh screen, such as less than about 30% but not less than about 24%, and lesser percentage of particles that are retained on an 80 mesh screen, such as less than about 4% but not less than about 2%. The inventive sweetener composition can be further characterized by having particles that are retained on a 16 mesh screen of at least about 3% but not more than about 9%, preferably about 6%; particles that are retained on a 30 mesh screen of at least about 31% but not more than about 39%, preferably about 35%; particles that are retained on 140 mesh screen of at least about 1.5% but not more than about 8%, preferably about 4.5%; and less than about 2% that fall through to the pan. The weight percentages above are determined by mean values using a Ro-Tap sieve with the following U.S. Standard sieves numbered 16, 20, 30, 60, 80, 140 and Pan. In each instance, the percent by weight is measured as a mean value using at least 10 representative samples in a Ro-Tap sieve.

The particle size for the particles in a preferred sweetener composition, as measured in a Ro-Tap sieve having the following U.S. Standard sieves numbered 16, 20, 30, 60, 80, 140 and Pan, is characterized, at least in part, by:

| | Granulated Product |
|---|---|
| Mesh Size | % by weight |
| 20 | About 21 |
| 60 | About 27 |
| 80 | About 3 |

In an alternative embodiment, the present invention relates to a bulked granulated sweetener composition comprising at least about 25% by weight of sweetener particles that are retained on a #30 mesh screen or smaller (meaning larger particles). A further embodiment is a bulked granulated sweetener composition comprising at least about 20% by weight of sweetener particles that are retained on mesh screens numbered between (including the end points) 20 and 30. A further embodiment is a bulked granulated sweetener composition comprising at least about 3% by weight of sweetener particles that are retained on #16 mesh screens. In each instance, the percent by weight is measured as a mean value using at least 10 representative samples in a Ro-Tap sieve.

The systematic set-up for these unit operations along with the feed composition produce a granulated low calorie sugar substitute finished product that dissolves faster and, which is rigid, has large and generally uniform particle sizes, and less-to-no dusty characteristics. Applicants have found that some or all of the following process modifications are necessary to produce the desired bulked granulated sweetener composition: 1) introducing the spray solution into the spray chamber within a specific viscosity range; 2) adding sucralose-containing spray solution at a pre-defined weight percentage to the feed; and 3) positioning the feed for liquid CO₂ after the HPP.

In an alternative embodiment of the present invention, the resulting granulated sweetener compositions have improved dissolution characteristics relative to the sugar substitute compositions in the market. A inventive granulated sweetener composition containing sucralose will dissolve in selected liquid mediums, such as those described in the following examples, in not more than 41 seconds, preferably not more than 36 seconds, most preferably not more than 31 seconds.

The invention is illustrated further by the following non-limiting Examples.

### EXAMPLE 1

A finished product is produced in accordance with the procedures described above using the following raw material:

Maltodextrin (DE10), sucralose and water are mixed in a ratio of (58:1.2:40.8) into a jacked mix tank to produce a spray feed solution. The spray feed solution is pumped into a jacketed holding tank. Using a high-pressure pump (HPP), the spray feed solution is pumped into a spray dryer chamber through nozzles that atomize the liquid. Liquid carbon dioxide is injected into the line carrying the spray feed solution at a point between the HPP and the spray dry nozzles.

The spray dry feed solution and liquid carbon dioxide, at approximately 40-45% moisture, is spray dried in the spray dry chamber at an inlet temperature of 330 F and an outlet temperature of 210 F and exit the spray dry chamber in particle form having approximately 3-5% moisture content. The spray dry chamber consists of a main chamber zone and an integrated fluidized bed zone.

The particulate product exiting from the integrated fluidized bed is discharged into an external fluidized bed to remove fines, further agglomerate the particles and adjust the moisture content of the resulting granulated product. From the external fluidized bed, the granulated product passes through a sifter to remove over-sized particles and produce the desired granulated bulked sweetener composition.

The resulting granulated bulk sweetener product has a particle size distribution of:

| Sieve Number | | |
|---|---|---|
| U.S. Standard | Micron Range | Particle size: % Retained |
| #16 | >1990 | 5.36 |
| #20 | 841–1990 | 21.42 |
| #30 | 595–841 | 36.98 |
| #60 | 250–595 | 27.12 |
| #80 | 177–250 | 3.0 |
| #140 | 105–177 | 3.58 |
| Through Pan | <105 | 2.14 |

The particle size measurement consists of weighing out 50 grams of material (±0.01 g) and determining the particulate distribution with a Ro-Tap particle size instrument. The Ro-Tap has a series of sieves with the following U.S. Standard number 16, 20, 30, 60, 80, 140 and Pan. The weighed product is placed on the sieve number 16 and the equipment is shaken for exactly 5 minutes. The retained product on each sieve is weighed and the percentage is calculated from the original amount (i.e. 50 g). Five different samples are used for the particle size analysis. It is accurate to within +/−1.0% of the range in use and is reproducible within +/−0.05%.

The resulting finished granulated sweetener product has degradation and dissolution properties as follows:

| | | | Altern No | Splenda |
|---|---|---|---|---|
| Degradation and | Inventive | | Calorie | granular |
| Rigidity Study | Product | Equal Spoonful | Sweetener | (Davisco) |
| Density before | 0.102 | 0.075 | 0.108 | 0.102 |
| tapping [g/cc] | | | | |
| Sample #1 | 0.113 | 0.128 | 0.146 | 0.119 |
| Tapped [g/cc] | | | | |
| Sample #2 | 0.116 | 0.135 | 0.149 | 0.126 |
| Tapped [g/cc] | | | | |
| Sample #3 | 0.106 | 0.137 | 0.152 | 0.123 |
| Tapped [g/cc] | | | | |
| Mean [g/cc] | 0.112 | 0.133 | 0.149 | 0.123 |
| Percent | 9.5 | 77.8 | 38.0 | 20.3 |
| Degradation | | | | |

The degradation and rigidity study consists of testing the loose bulk density in gram per cubic centimeter (g/cc) of each sample three times and tapping the product to determine the change in density. To test the loose bulk density, the sample is filled in a known volumetric container. The fill amount is weighed and the density is determined in g/cc. The principle of tap bulk density works by taking and weighing a specified volume of product. The product is then tapped to measure any changes in its volume. Such treatment is an indication of changes that may occur in product density during shipping or handling. The measure can also be used to examine the physical changes in product characteristics (e.g. particle breakage) that may occur during transportation handling or storage. A stampfvolumeter or equivalent is used for tap bulk density measurement. A specific volume i.e. 250 cc of the product is weighed and tapped exactly 100 times. After tapping, the reduction of its volume is recorded and the product is weighed. The tap bulk density in g/cc is the weight of the product divided by the decreased in volume. For example, if the density of a sample decreases significantly from its pre-tapped value, it means that the product is fragile and the particle size is not strong enough.

### Dissolution Study: Analytical Results

The dissolution study consists of weighing exactly 1.0 gram of each product and pouring into a 200 ml of hot coffee at 155° F.±2° F. The dissolution time is measured in seconds. This test is repeated 3 times.

| | | | Altern No | Splenda |
|---|---|---|---|---|
| Dissolution | | Equal | Calorie | granular |
| Time | Inventive | Spoonful | Sweetener | (Davisco) |
| Sample #1 | 30 sec | >70 sec | >80 sec | >73 sec |
| Sample #2 | 34 sec | >80 sec | >82 sec | >89 sec |
| Sample #3 | 28 sec | >75 sec | >92 sec | >75 sec |
| Average | 31 sec | 75 sec | 85 sec | 79 sec |

### EXAMPLE 2

### Comparison of Particle Sizes for Inventive, Equal and Wal-Mart Granular Sweetener Samples

A statistical analysis was performed on the inventive granulated product (Form 1), Equal (Form 2) and Wal-Mart brand (Form 3) granular samples to assess the distribution of the particle size in the range of 595 and 1990 microns and above 1990 microns. The particle size measurement consists of weighing out 50 grams of material (±0.01 g) and determining the particulate distribution with a Ro-Tap particle size instrument. The Ro-Tap has a series of sieves with the following U.S. Standard number 16, 20, 30, 60, 80, 140 and Pan. The weighed product is placed on the sieve number 16 and the equipment is shaken for exactly 5 minutes. The retained product on each sieve is weighed and the percentage is calculated from the original amount of approximately 50 g. Five different samples are used for the particle size analysis. It is accurate to within +/−1.0% of the range in use and is reproducible within +/−0.05%.).

2a—Form 1 Versus Form 2

Ten (10) samples with the sample size of 50 g each, for both of the granulated products were measured to determine the percentage of particles falling within the range of 595 to 1990 microns. The sample mean percentage of particles for the Form 1 granulated product having a particle size between 595 and 1990 microns was 32.05% (16.03 g in 50 g of test samples), while the sample mean value for the Form 2 granulated product was 12.59% (6.30 g in 50 g of test samples). The average percentage of particles having a particle size between 595 and 1990 microns in the Form 1 granulated product was 154.57% greater than the average percentage of corresponding particles in the Form 2 granulated product.

The sample mean percentage of particles for the Form 1 granulated product having a particle size greater than 1990 microns was 5.36%. The minimum percentage of all samples for the Form 1 granulated product having a particle size greater than 1990 microns was 3.30%, the maximum percentage was 7.8% and the standard deviation was 1.67. The 95% confidence interval for the sample mean percentages of particles having a particle size greater than 1990 microns was between 3.29% and 7.43%.

The sample mean percentage of particles for the Form 2 granulated product having a particle size greater than 1990 microns was 0.66%. The minimum percentage of all samples for the Form 2 granulated product having a particle size greater than 1990 microns was 0.50%, the maximum percentage was 0.80% and the standard deviation was 0.15. The 95% confidence interval for the sample mean percentages of particles having a particle size greater than 1990 microns was between 0.47% and 0.85%. The average percentage of particles having a particle size greater than 1990 microns in the Form 1 granulated product was 712.12% greater than the average percentage of corresponding particles in the Form 2 granulated product.

A t-Test was performed to determine whether the two sample groups (sample size 10) were statistically different. At 95% confidence interval, the P-value of the t-test was 0.00, which was less than 0.05 indicating a statistical significant difference as between the particle size of the Form 1 particles and the Form 2 particles.

2b—Form 1 Versus Form 3

Ten (10) samples (with the sample size of 50 g each) for both of the granulated products were measured to determine the percentage of particles falling within the range of 595 to 1990 microns. The sample mean percentage of particles for the Form 1 granulated product having a particle size between 595 and 1990 microns was 32.05% (16.03 g in 50 g of test samples), while the sample mean value for the Form 3 granulated product was 13.2% (6.6 g in 50 g of test samples). The average percentage of particles having a particle size between 595 and 1990 microns in the Form 1 granulated product was 142.80% greater than the average percentage of corresponding particles in the Form 3 granulated product.

As noted above, the sample mean percentage of particles for the Form 1 granulated product having a particle size greater than 1990 microns was 5.36%. The minimum percentage of all samples for the Form 1 granulated product having a particle size greater than 1990 microns was 3.30%, the maximum percentage was 7.8% and the standard deviation was 1.67. The 95% confidence interval for the sample mean percentages of particles having a particle size greater than 1990 microns was between 3.29% and 7.43%.

The sample mean percentage of particles for the Form 3 granulated product having a particle size greater than 1990 microns was 1.06%. The minimum percentage of all samples for the Form 3 granulated product having a particle size greater than 1990 microns was 0.80%, the maximum percentage was 1.30% and the standard deviation was 0.21. The 95% confidence interval for the sample mean percentages of particles having a particle size greater than 1990 microns was between 0.80% and 1.32%. The average percentage of particles having a particle size greater than 1990 microns in the Form 1 granulated product was 405.66% greater than the average percentage of corresponding particles in the Form 3 granulated product.

A t-Test was performed to determine whether the two sample groups (sample size 10) were statistically different. At 95% confidence interval, the P-value of the t-test was 0.00, which was less than 0.05 indicating a statistical significant difference as between the particle size of the Form 1 particles and the Form 3 particles.

I/We claim:

1. A bulked granulated sweetener composition comprising at least about 25% by weight of sweetener particles having a particle size greater than 595 microns, where said percent by weight is measured as a mean value using at least 10 representative samples in a Ro-Tap sieve.

2. A bulked granulated sweetener composition comprising at least about 20% by weight of sweetener particles having a particle size in the range of 595 and 1990 microns, where said percent by weight is measured as a mean value using at least 10 representative samples in a Ro-Tap sieve.

3. A bulked granulated sweetener composition comprising at least about 3% by weight of sweetener particles having a particle size greater than 1990 microns, where said percent by weight is measured as a mean value using at least 10 representative samples in a Ro-Tap sieve.

4. A bulked granulated sweetener composition comprising an intimate mixture of maltodextrin and sucralose having a loose bulk density not greater than 0.15 g/cm³.

5. A bulked granulated sweetener according to any one of claims 1 to 4 wherein the high intensity sweetener is selected from the group consisting of sucralose, aspartame, saccharin, cyclamate, neotame, alitame, acesulfame potassium; brazien; stevia extract; and their salts and derivatives thereof, and mixtures thereof.

6. A bulked granulated sweetener according to any one of claims 1 to 4 wherein the high intensity sweetener is sucralose or a blend of sucralose with another high intensity sweetener.

7. A bulked granulated sweetener according to any one of claims 1 to 4 wherein the high intensity sweetener is sucralose.

8. A bulked granulated sweetener composition according to claim 7 wherein the sucralose and maltodextrin adhere to one another.

9. A bulked granulated sweetener composition according to claim 8 wherein the maltodextrin and sucralose adhere to one another in a particle form.

10. A bulked granulated sweetener composition according to claim 9 wherein the particles are generally globular and at least about 18% by weight are retained on a 20 mesh screen.

11. A bulked granulated sweetener composition according to claim 10 wherein not more than about 24% by weight of the particles are retained on a 20 mesh screen.

12. A bulked granulated sweetener composition according to claim 10 wherein about 24% to about 30% by weight of the particles are retained on a 60 mesh screen and about 2% to about 4% by weight of the particles are retained on an 80 mesh screen.

13. A bulked granulated sweetener composition according to claim 10 wherein not more than about 14% by weight of the particles pass through a 60 mesh screen.

14. A bulked granulated sweetener composition according to claim 13 wherein not more than about 9% by weight of the particles are retained on a 16 mesh screen.

15. A bulked granulated sweetener composition according to claim 13 wherein at least about 73% by weight of the particles are retained on screens between 20 mesh and 60 mesh.

16. A bulked granulated sweetener composition according to claim 9 wherein about 21% by weight of the particles are retained on 20 mesh screen, about 27% by weight of the particles are retained on a 60 mesh screen, and about 3% by weight of the particles are retained on an 80 mesh screen.

17. A bulked granulated sweetener composition according to claim 16 wherein the solution introduced into the spray drying chamber comprises between about 1.1% to about 5% sucralose and between about 95% and 99.9% maltodextrin, on a dry weight basis.

18. A process for making a granulated sweetener composition comprising;
a. introducing a solution comprising maltodextrin and sucralose into a spray drying chamber;
b. atomizing the solution;
c. drying the solution to produce solid particles of maltodextrin and sucralose; and
d. screening the resulting particles to produce a bulked granulated sweetener composition,
wherein prior to introducing the solution comprising maltodextrin and sucralose into the spray drying chamber, carbon dioxide is added to the solution.

19. A process according to claim 18 wherein the carbon dioxide is introduced after the solution has passed through a high-pressure pump.

20. A process according to claim 19 wherein the carbon dioxide is in liquid form.

21. A process according to claim 19 wherein the solution introduced into the spray drying chamber comprises between about 1.1% to about 5% sucralose and between about 95% and 99.9% maltodextrin, on a dry weight basis.

22. A process according to claim 19 wherein the viscosity of the solution comprising maltodextrin and sucralose is about 190 cps to about 300 cps at the selected operating temperatures for holding the solution prior to introducing said solution into the spray drying chamber.

23. A process according to claim 19 wherein the viscosity of the solution comprising maltodextrin and sucralose is about 250 cps at the selected operating temperatures for holding the solution prior to introducing said solution into the spray drying chamber.
